(19) United States
(12) Patent Application Publication
(10) Pub. No.: US 2003/0103475 A1
(43) Pub. Date: Jun. 5, 2003

(54) Two-way timing and calibration methods for time division multiple access radio networks

(76) Inventors: Stephen B. Heppe, Hood River, OR (US); Steven Friedman, Bethesda, MD (US); Prasad Nair, Bethesda, MD (US)

Correspondence Address: BLANK ROME COMISKY & MCCAULEY, LLP, 900 17TH STREET, N.W., SUITE 1000, WASHINGTON, DC, 20006, US

(21) Appl. No.: 10/190,691

(22) Filed: Jul. 9, 2002

Related U.S. Application Data
(60) Provisional application No. 60/303,512, filed on Jul. 9, 2001.

(51) Int. Cl. H04B 7/212

(52) U.S. Cl. 370/321; 370/337

(57) ABSTRACT

The present invention is an augmentation of the current international standards for STDMA networks, which allows a station A to determine system time from a single other station B even if the station A does not have knowledge of its own location. The present invention also allows a station A, knowing its own location and system time, to determine the group delay in its own transmit chain through an interaction with another station B which also has knowledge of its location and system time, and has previously calibrated its own group delay variations (for the transmit and receive chains).

### FIELD OF INVENTION

The present invention is directed to the provision of alternative means of time determination and calibration in time division multiple access radio networks.

### BACKGROUND OF THE INVENTION

The International Civil Aviation Organization (ICAO) has recently approved international standards for a self-organizing time-division multiple access (STDMA or SOTDMA) radio communications system known as VHF Data Link Mode 4 (VDL/4). The International Maritime Organization (IMO) has recently approved international standards for a SOTDMA radio communications system known as ITU-R M.1371-1. These systems are substantially similar in that both implement a radio communications system with multiple frequencies and multiple contiguous time slots on each frequency. Messages transmitted over the radio network are placed in one or more time slots and the multiple-access protocol provides a mechanism for individual stations to reserve future time slots for expected future transmissions. Channel resources are allocated in units of time slots, and efficient operation requires that the minimum number of time slots be used for a given message size.

Proper operation of an STDMA network requires that each radio station (installed e.g. on a mobile platform or at a fixed base station) have accurate knowledge of system time which is typically aligned with Universal Coordinated Time (UTC). If some or all of the radio stations lack sufficiently accurate knowledge of system time, or are unable to transmit messages within time slots with a sufficient degree of time synchronization, the STDMA radio network will incur a reduction in efficiency due to messages appearing to straddle N+1 time slots when ideal time synchronization would have only required N time slots.

In the case of the VDL/4, an observer located at the transmitting antenna of a station should observe the start time of an individual transmit event occurring within 1 usec of the nominal start time of a time slot, relative to the local clock of the transmitting station. The local clock should be calibrated with UTC. The station may be required to compensate for signal propagation delays in its transmitting equipment in order to achieve this level of time synchronization at the antenna. There are 75 time slots every second, and the start of a UTC second corresponds with the start of a slot. In the case of ITU-R M.1371-1, there are 75 time slots every 2 seconds and the start of every other UTC second corresponds to the start of a slot. The start times of individual transmit events in an STDMA network conforming to ITU-R M.1371-1 are required to occur within 104 usec of the start of a slot as determined by the station's synchronization source. A station can derive time directly from GPS or GNSS in which case the synchronization error relative to UTC is allowed to be +/−104 usec. Alternatively, a station can derive time from a chain of sources containing up to two other stations, in which case the synchronization error relative to UTC is allowed to be +/−208 usec (for one station) or +/−312 usec (for two stations).

Several methods are available to provide the necessary level of time synchronization in an STDMA station. Each station may contain a Global Positioning System (GPS) or Global Navigation Satellite System (GNSS) receiver, which can provide an accurate estimate of UTC. Alternatively, if the station has an accurate estimate of its own position and can estimate the arrival time of a message from another STDMA station which has reported its position, the propagation time of the message can be calculated from knowledge of the speed of light. If the transmitting station has declared that it is synchronized to UTC (to some level of accuracy), a slot strobe at the receiving station can then be aligned with the nominal start times of the time slots as clocked at the transmitting station. Further processing, possibly involving additional information transmitted from the transmitting station to the receiving station, can be used to determine the relationship of a time slot to a UTC second. Finally, if a STDMA station has no knowledge of its own location, but can receive position reports from a sufficient number of STDMA stations which declare that they are synchronized to UTC, a rough estimate of time can be generated by a process similar to that employed in the GPS and GNSS systems (solving for station position and clock offset given a sufficient number of message arrival time measurements).

If the station has an accurate estimate of its own position and time (e.g., from GPS or GNSS) and can estimate the arrival time of a message from another STDMA station which has reported its position, and which has declared it is synchronized to UTC (to some level of accuracy), the propagation time of the message can be calculated from knowledge of the speed of light and the group delay in the receive chain of the station can be estimated as the residual delay after subtracting the calculated propagation time from the observed message arrival time (relative to the nominal slot start time). Averaging and other techniques can be used to smooth the estimate of the group delay in the receive chain.

There is currently no method for an STDMA station A to determine system time from a single other STDMA station B, if station A lacks knowledge of its own location.

There is currently no method for an STDMA station A to determine the group delay through its own transmit chain based on messages which can be exchanged between stations, even though this transmit chain group delay is a potentially important parameter allowing a station to control the effective transmit times of its transmissions.

### SUMMARY OF THE INVENTION

This invention is an augmentation of the current international standards for STDMA networks, which allows a station A compliant with this invention to determine system time from a single other station B compliant with this invention even if the compliant station A does not have knowledge of its own location. This invention also allows a station A compliant with this invention, and knowing its own location and system time, to determine the group delay in its own transmit chain through an interaction with another station B compliant with this invention which also has knowledge of its location and system time, and has previously calibrated its own group delay variations (for the transmit and receive chains).

### BRIEF DESCRIPTION OF THE DRAWINGS

FIG. 1 illustrates a conceptual method for determining system time using a two-way ranging measurement.

FIG. 2 illustrates a two-way rnaging measurement suitable for time-slotted systems, which enables the determination of a time error between two stations.

FIG. 3 illustrates a message format for a base station message for a preferred embodiment of the present invention that would enable the two-way timing and calibration in a VDL/4 network.

FIG. 4 illustrates a message format for a preferred embodiment of the present invention that would enable a request, by a mobile station in a VDL/4 network, for two-way timing and calibration data.

### DETAILED DESCRIPTION OF THE INVENTION

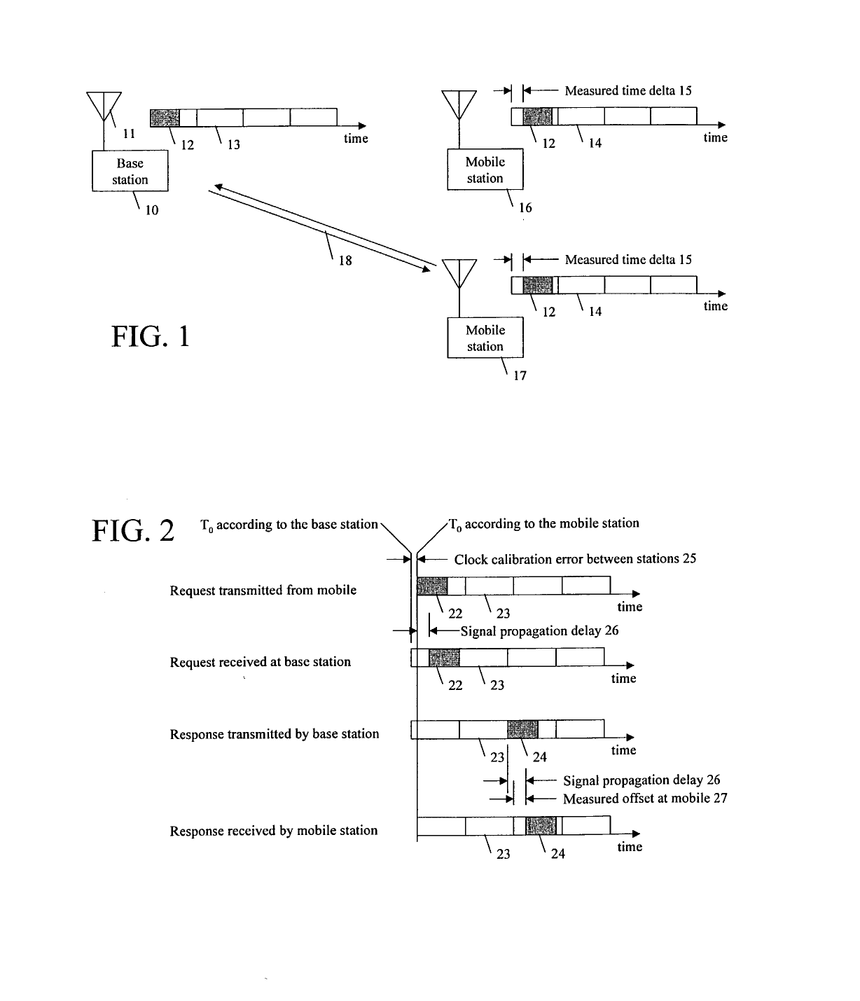

In FIG. 1, a base station 10 with accurate knowledge of system time transmits messages 12 using electromagnetic signals in certain time slots 13 whose start times are synchronized to UTC. The messages 12 are synchronized within the time slots 13, for example in FIG. 1 the messages occur at the beginning of the time slots. In one preferred embodiment the time slots are synchronized within a fraction of 1 usec with respect to UTC and the messages are synchronized within a time slot within 1 usec. However the synchronization fidelity may vary from one embodiment to another and may depend to a greater or lesser degree on system requirements.

According to the existing international standards for VDL/4 and ITU-R M.1371-1, a subset of the messages transmitted by the base station contain information describing the position of the base station. This information or information derived from this information is stored in a memory means within the mobile station.

A mobile station 16 without knowledge of system time would perceive the messages 12 as occurring at an arbitrary offset 15 relative to time slots 14 synchronized to its own local clock. Note that the time slots 14 known to the mobile station 16 have the same duration as the time slots 13 known to the base station 10, and are expected to be one-to-one related, but have an arbitrary time shift due to unknown clock calibration error at the mobile station 16 relative to the base station 10. The measured time delta 15, of the received message 12 within a time slot 14, has at least three significant components: 1) the clock calibration error between the base station and the mobile station; 2) the propagation time for the electromagnetic signal between the base station and the mobile station; and 3) the receive chain processing delay in the mobile station.

If the mobile station knows its own location and receive chain processing delay, and has previously stored the location of the base station in an internal memory means, the propagation time and receive chain processing delay can be determined and subtracted from the measured time delta 15. The remaining time delta can be used as an estimate of the clock calibration error between the base station 10 and the mobile station 16, and used to adjust the clock of the mobile station.¹ This method can be used even if the mobile station does not know its own receive chain processing delay, but in this case the accuracy of the clock adjustment will be impaired. ¹ There may be an integer ambiguity regarding the ID of the time slot itself, but this may be immaterial in a particular system (such as VDL/4). If the integer slot ID is significant, further processing can be applied to remove it.

If a mobile station 17 does not know its own location, two-way propagation delay can be measured (e.g., with a radar system which transmits and subsequently receives an echo of its transmission 18 reflected from the base station) and the one-way propagation delay can be calculated as half of the two-way propagation delay. This calculated one-way propagation delay can be subtracted from the measured time delta 15, and the remainder is an estimate of the clock calibration error between the base station 10 and the mobile station 17. A similar two-way range measurement can be made with a radio repeater at the base station having a fixed and known repeater delay—in this case the mobile measures the two-way system propagation delay and subtracts the fixed and known repeater delay before dividing by 2 to determine the one-way RF propagation delay. This is an example of a two-way time distribution and calibration method.

It should be understood that the base station 10 need not be in a fixed location according to the current invention, although this may be the typical operational mode.

FIG. 2 illustrates a time flow diagram for a modification of the two-way time distribution method illustrated in FIG. 1, which according to the current invention is suitable for time-slotted radio communication systems. In this figure, a mobile station transmits a request 22 that is synchronized within a slot (one of a multiplicity of time slots 23) according to its local clock. For example, in FIG. 2 the request 22 is transmitted at the start of a slot according to the mobile station's local clock. The request is received at a base station. Due to propagation delay and calibration error between the stations, the request appears to arrive at the base station with a time offset relative to the start of a slot as determined by the local clock of the base station. For example, in the case illustrated in FIG. 2 the offset as observed at the base station is the sum of the clock calibration error 25 between the stations and the signal propagation delay 26 between the stations. The apparent arrival time of this request within the time slot, as observed at the base station, is reported back to the mobile within a response message 24 that is synchronized within a slot according to the clock of the base station (which in a preferred embodiment is presumed to be aligned with UTC). For example, in FIG. 2 the response 24 is transmitted at the start of a slot according to the base station's local clock. The apparent arrival time of this response message 24 is measured at the mobile station, according to the local clock of the mobile station, and the information contained therein, including the arrival time measurement at the base station, is read.

If the clocks were aligned and there were no extra delays in the equipment of the mobile station and the base station, and all measurements were made with zero error, the arrival time measurement made at the base station would be equal to the arrival time measurement made at the mobile station.

If the clocks are not aligned, but delays in the equipment are zero, the difference in arrival time measurements yields twice the clock error between the mobile station and the base station. If the arrival time measurement 27 at the mobile station is smaller than the arrival time measurement reported by the base station in the response message 24, than the local clock of the mobile station is “late” relative to the local clock of the base station, and the mobile station should advance its estimate of current time in order to bring its local clock into alignment with the local clock of the base station. Alternatively, if the arrival time measurement 27 at the mobile station is larger than the arrival time measurement reported by the base station in the response message 24, than the local clock of the mobile station is “early” relative to the local clock of the base station, and the mobile station should retard its estimate of current time in order to bring its local clock into alignment with the local clock of the base station.

In a preferred embodiment of a two-way time distribution method suitable for time-slotted radio communications systems according to the current invention, it may be assumed that internal timing delays of the base station, for both reception and transmission, have been calibrated. The transmissions from the base station may be assumed, for purposes of description, to radiate from the antenna at the beginning of the intended time slots (the transmit times having been adjusted to account for the hardware delays in the transmit chain, so that the transmissions occur at the correct time referenced to the antenna).

When a mobile station knows its own location and system time, its time slots are aligned with those of the base station (since both know system time) and the propagation delay can be calculated (since the mobile knows its own location and that of the base station). Any offset between the measured arrival time at the mobile station, and the calculated and predicted arrival time given the known positions of the two stations, must correspond to the mobile station's receive processing delay (it is recognized that a single measurement may be noisy and smoothing or other techniques may be required to avoid sudden or undesirable jumps in estimated receive processing delay). Similarly, any offset reported by the base station, which remains after subtracting the known and predicted propagation delay between the two stations, must correspond to the mobile station's transmit processing delay.

Using the methods of the current invention, a mobile station can determine its own transmit chain processing delay in the field during normal operation (i.e., without factory calibration or measurement at the time of installation). Processing delay may vary over time and with ambient conditions, but the delay variation is typically small compared to the total delay as long as the hardware configuration remains unchanged. Information regarding the transmit chain processing delay can be stored in a memory means within the mobile station for later use. Since the variations tend to be small compared to the total delay, this information can be used even when system time and position are not known.

Using the methods of the current invention, a mobile station that has previously calibrated its own transmit chain processing delay (and also knows its receive chain processing delay) can determine system time even if its position is not known.

Errors in measurement, and small variations in physical parameters, will degrade the calibration accuracy of a mobile station with regard to transmit chain processing delay and system time. Those skilled in the art will recognize that several techniques exist to mitigate the effects of measurement error and the effects of small changes in physical parameters. For example, measurement errors can be mitigated with multiple measurements and filtering.

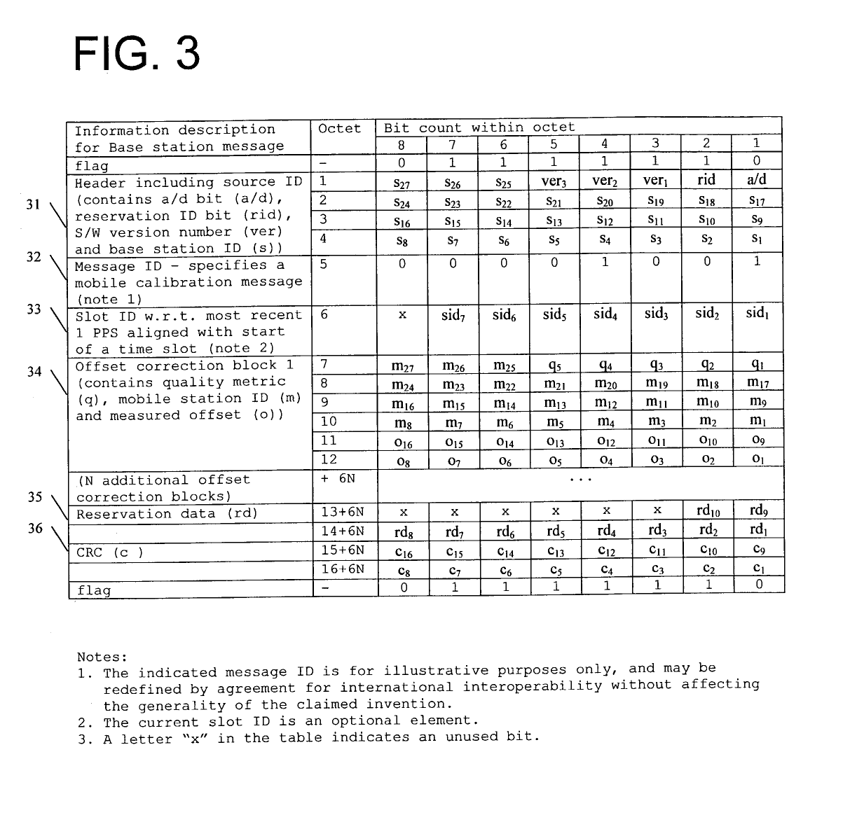

FIG. 3 illustrates a message format according to a preferred embodiment of the present invention tailored to the ICAO standard for VDL/4. This message format allows an arbitrary station A to report the measured arrival time offset of a message from another arbitrary station B, said offset occurring between the start of a slot as known to station A and the message from station B (either its beginning, or a known point within the message such as the end of a training sequence). The message format is general in the sense that several such arrival time measurements can be reported in a single message, said several arrival time measurements corresponding to the measured arrival times of messages from several arbitrary stations B, C, D, . . . , N. The message comprises the following elements:

a) a header 31 which is predefined in the VDL/4 standard and contains the station ID of the transmitting station A;

b) a message ID 32 which indicates that this message contains the information according to the present invention (the bit pattern could be modified without straying from the intent of the invention);

c) a slot ID (optional) 33 which indicates the slot ID containing the start of this message according to the most recent 1 PPS strobe of the transmit station's clock which was aligned with the start of a slot (this index will be between 1 and 75 for the ICAO and IMO standards currently promulgated);

d) N occurances of an offset correction block (OCB), 34, each of which contains a quality metric, mobile station ID and offset. For VDL/4 using a preferred embodiment of the present invention, the quality metric is a 5-bit field containing an uncertainty metric describing the relative uncertainty in the accuracy of the arrival time measurement or a “don't use” flag, the mobile station ID is a 27-bit ID, and the offset is a 16-bit field describing time in 0.25 usec increments relative to the start of a slot;

e) reservation data 35 which can indicate e.g. a null reservation according to the VDL/4 standard (if this is a response to a unicast interrogation from a mobile station) or e.g. one message in a periodic stream of messages according to the VDL/4 standard;

f) a CRC check 36 used to protect the integrity of the data.

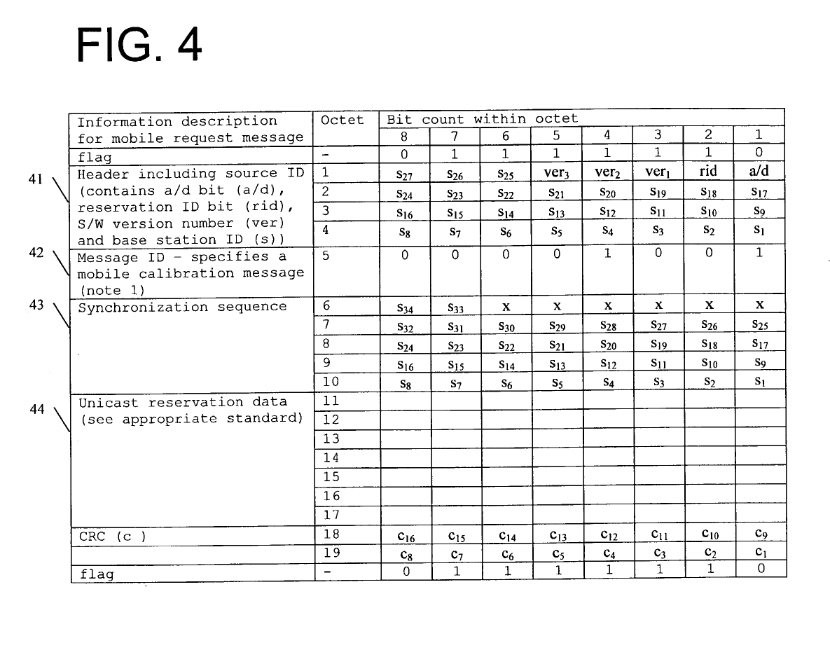

In the VDL/4 standard, a mobile station can request an arbitrary message from a peer station using a unicast request/response protocol, so a mobile station can demand the message illustrated in FIG. 3 from a base station if the two stations are compliant with this invention and hence agree on the meaning of the message ID. FIG. 4 illustrates an example of a request message tailored to the VDL/4 standard, which could be used by a mobile station operating in a VDL/4 network to request an OCB from a base station. The message contains a standard message header 41. The message ID 42 (which is the same as the message ID illustrated in FIG. 3 for the base station message), processed in combination with the unicast reservation encoding 44 of octets 11 through 17, indicates that this is a unicast request by the mobile station to a particular base station (identified within the unicast reservation data block), and that the base station should respond in a particular time slot which is also indicated in the unicast reservation data block. The optional synchronization sequence 43 provides a predefined bit pattern for enhanced message arrival time measurement accuracy. It should be tailored to provide optimum measurement accuracy when considered along with the message pre-key and starting frame flag.

The VDL/4 standard currently incorporates bit stuffing. In a preferred embodiment of the present invention the optional synchronization sequence 43 is located at a fixed number of bit positions from the starting frame flag. The fill bits in octet 6 may be absorbed by bit stuffing or filled with zeros in order to enable this fixed spacing relationship.

In another preferred embodiment of the present invention, the entire message is used as a synchronization sequence for the purpose of arrival time measurement (e.g., using decision-directed feedback to specify the bit sequence of the entire message after the message is demodulated and checked for errors).

In the case where a mobile station requests an OCB from a base station, the base station would typically respond with a message containing a single OCB. The response is not acknowledged. However, other procedures and protocols are feasible.

In certain systems other than VDL/4, another message may need to be defined in order to request a base station to transmit this information on demand.

A base station can autonomously transmit a message with one or multiple OCB's, reporting on one station or a set of stations. In one preferred embodiment, the base station reports periodically or aperiodically on a subset of the stations with measured offsets larger than a predetermined threshold. The subset may be selected as the set of all said stations (with measured offsets larger than a predetermined threshold) based on known distance from the base station (if distances are known), or estimated quality metric, or other decision criteria. Messages may also contain only a subset of stations, with multiple messages used to report in aggregate the total set.

In a preferred embodiment of the present invention tailored to the VDL/4 protocol, the base station can report its predetermined threshold with a broadcast XID parameter.

I claim:

1. A method for calibrating the transmit chain processing delay of a mobile station, said mobile station operating in a time-slotted communications system using electromagnetic radiation for the transmission of messages, said mobile station having current knowledge of system time and its own location, said transmission of messages synchronized in time with respect to the time slots of said time-slotted communications system, said time slots synchronized to a clock at a base station, said method of calibration comprising the steps of:
a) transmitting the position of said base station and storing the position of said base station in a memory means within said mobile station,
b) transmitting a calibration request message from said mobile station,
c) measuring the arrival time of said request message at said base station relative to a time slot of said time-slotted communications system,
d) reporting said arrival time measurement to said mobile station by means of a response message,
e) subtracting the propagation delay of electromagnetic radiation propagating from the mobile station to the base station, as calculated from knowledge of the base station position and the mobile station position, from said arrival time measurement reported in said response message, and
f) applying the remainder of said subtraction as an estimate of the uncalibrated excess delay in the transmit chain of said mobile station.

2. The method of claim 1 wherein the request message contains a predefined data sequence, with a fixed time offset relative to the start of the message, said data sequence designed to enhance the accuracy of the arrival time measurement relative to the start of a slot.

3. A method for calibrating the transmit chain processing delay of a mobile station, said mobile station operating in a time-slotted communications system using electromagnetic radiation for the transmission of messages, said mobile station having current knowledge of system time and its own location, said transmission of messages synchronized in time with respect to the time slots of said time-slotted communications system, said time slots synchronized to a clock at a base station, said method of calibration comprising the steps of:
a) transmitting the position of said base station and storing the position of said base station in a memory means within said mobile station,
b) measuring the arrival time of arbitrary messages from one or a plurality of mobile stations at said base station relative to time slots of said time-slotted communications system,
c) reporting said arrival time measurement(s) to at least one of said mobile station(s) by means of a response message or set of response messages,
d) subtracting the propagation delay of electromagnetic radiation propagating from the mobile station to the base station, as calculated from knowledge of the base station position and the mobile station position, from said arrival time measurement reported in said response message, and
e) applying the remainder of said subtraction as an estimate of the uncalibrated excess delay in the transmit chain of said mobile station.

4. A method for adjusting the clock of a mobile station, said mobile station operating in a time-slotted communications system using electromagnetic radiation for the transmission of messages, said time slots synchronized to a clock at a base station, said method of clock adjustment comprising the steps of:
a) transmitting a calibration request message from said mobile station,
b) measuring the arrival time of said request message at said base station relative to a time slot of said time-slotted communications system,
c) reporting said arrival time measurement to said mobile station by means of a response message,
d) measuring the arrival time of said response message at said mobile station relative to a time slot of said time-slotted communications system according to the local clock of the mobile station,
e) calculating the difference in arrival time measurements between the arrival time measurement reported by the base station and the arrival time measured by the mobile station, and
f) applying one half of said difference as an estimate of the clock error.

5. The method of claim 4 wherein the request message contains a predefined data sequence, with a fixed time offset relative to the start of the message, said data sequence designed to enhance the accuracy of the arrival time measurement relative to the start of a slot.

6. The method of claim 4 wherein the mobile station has previously calibrated its transmit chain processing delay and receive chain processing delay.

7. The method of claim 4 wherein the measurement of base station message arrival time at the mobile station is derived from at least one message transmitted by the base station which does not contain the reported message arrival time of the mobile station's message at the base station.

8. A method for adjusting the clock of a mobile station, said mobile station operating in a time-slotted communications system using electromagnetic radiation for the transmission of messages, said time slots synchronized to a clock at a base station, said method of clock adjustment comprising the steps of:
a) measuring the arrival time of arbitrary messages from one or a plurality of mobile stations at said base station relative to time slots of said time-slotted communications system,
b) reporting said arrival time measurement(s) to at least one of said mobile station(s) by means of a response message or set of response messages,
c) measuring the arrival time of said response message, as it is received by at least one of said mobile station(s) whose arrival time measurement at the base station was reported by the base station, relative to a time slot of said time-slotted communications system according to the local clock of the mobile station,
d) calculating the difference in arrival time measurements between the arrival time measurement reported by the base station and the arrival time measured by the mobile station, and
e) applying one half of said difference as an estimate of the clock error.

9. The method of claim 8 wherein the mobile station has previously calibrated its transmit chain processing delay and receive chain processing delay.

10. The method of claim 8 wherein the measurement of base station message arrival time at the mobile station is derived from at least one message transmitted by the base station which does not contain the reported message arrival time of the mobile station's message at the base station.
